(19) United States
(12) Patent Application Publication
(10) Pub. No.: US 2011/0303815 A1
(43) Pub. Date: Dec. 15, 2011

(54) Workpiece Support Tool And Method Of Temporarily Mounting Workpieces Of Varying Shapes

(75) Inventors: Steve Donald Krohmer, Coon Rapids, MN (US); James J. Frey, Edina, MN (US); Daniel Wenning, Minneapolis, MN (US); Daniel P. Banasik, Eagan, MN (US)

(73) Assignee: Rockler Companies, Inc., Medina, MN (US)

(21) Appl. No.: 13/164,086

(22) Filed: Jun. 20, 2011

Related U.S. Application Data
(63) Continuation-in-part of application No. 29/358,982, filed on Apr. 2, 2010, now Pat. No. D640113.

(51) Int. Cl. F16M 13/02; B25B 11/00

(52) U.S. Cl. 248/354.1; 29/559

(57) ABSTRACT

An apparatus and method for supporting a workpiece against a wall (wall or ceiling surface) in order to further mount the workpiece, typically on the wall or ceiling. This helping tool allows a single person to hold a workpiece in place(s) at an elevation while working on final installation. The disclosure includes a knuckle member which at least two generally orthogonal passages therethrough which receive bars having wall pads. The bars can be positionally adjusted within the passageways to preferably create the appropriate shaped “box” enclosure to hold the workpiece. The preferred shape enclosure is the smallest which will hold the piece the closest to the wall surface while being adjustable for different sized workpieces.

### CROSS-REFERENCE TO RELATED APPLICATIONS

This application is a Continuation-In-Part of U.S. Ser. No. 29/358,982 filed 2 Apr. 2010 entitled CROWN MOLDING SUPPORT TOOL.

### BACKGROUND

1. Field of the Invention

The present disclosure is directed generally to an apparatus for supporting a molding piece or similar element against a wall surface during installation of the molding piece, and more particularly, to an adjustable apparatus that supports and positions various sizes and configurations of molding pieces against a wall surface enabling a single installer to install a molding piece against a wall surface at a desired position.

2. Description of the Related Art

Crown molding serves several important aesthetic and utilitarian functions, including the obscuring of the rough and abrupt intersection of a ceiling and wall, the general enhancement and refinement of the decor and design of a room, and the stabilization of some wall coverings where they intersect with a ceiling. However, because of the inherently elevated, overhead location of crown molding, installation can be cumbersome and difficult, and often requiring the cooperation of two or more workers due particularly to the length of crown molding to be installed. The prior art U.S. Pat. No. 7,603,817 (incorporated herein by reference for background information) accomplishes this task well, but it creates a fixed support “box” region (encapsulated space in the '817 patent) which the molding must fit within regardless of its shape and cross section. For example, small moldings would benefit from the box space (ie the confined space between arms of the support which form a box area with the wall) should be as small as possible, whereas a larger molding needs more box space. This prior art device cannot fully manage this problem.

### BRIEF SUMMARY OF THE DISCLOSURE

As stated there is an apparatus and method for supporting a workpiece against a wall (wall or ceiling surface) in order to further mount the workpiece, typically on the wall or ceiling. This helping tool allows a single person to hold a workpiece in place(s) at an elevation while working on final installation. The disclosure includes a knuckle member which at least two generally orthogonal passages therethrough which receive bars having wall pads. The bars can be positionally adjusted within the passageways to preferably create the appropriate shaped “box” enclosure to hold the workpiece. The preferred shape enclosure is the smallest which will hold the piece the closest to the wall surface while being adjustable for different sized workpieces.

Also disclosed is an improvement to an apparatus for supporting an elongated workpiece element against at least a wall surface at a distance from a floor surface, the apparatus having a handle having opposing first and second ends; a head assembly coupled to the first end of the handle, the head assembly being configured to support and surround a portion of the workpiece at a prescribed distance from said floor surface when said second end of said elongate body portion is adjacent said floor surface and said first end is adjacent said at least a wall, the improvement having a knuckle member, having at least two orthogonal passages there through, a pair of wall pads, configured to engage a wall; a pair of bars extended from the wall pads with at least a portion of which is sized to be slideably received within said passages; engagement members coupled to said knuckle member for engaging said bars to prevent movement of said bars within said knuckle when user-adjusted to a selected position; thereby creating user definable sides of a box area formed against wall surfaces.

Also disclosed is an apparatus, wherein said bars have a non-circular cross section, so that when inserted into said passages, they are prevented from rotating therein.

Also disclosed is an apparatus, wherein the pads include a high friction surface on their exterior face to engage wall surfaces without slippage.

Also disclosed is an apparatus, wherein the knuckle member includes rectangular passages sized to slideably receive said bars, and wherein said knuckle further includes at least one set screw positioned to engaged the passages and hence the bars to fix there position when the set screws are engaged on into the bars.

Also disclosed is an apparatus, wherein the knuckle further includes a pivot flange extending orthogonally from a surfaces thereof, said pivot flange being connected to the handle in such a way as to allow pivoting of the knuckle relative to the handle.

Also disclosed is an apparatus, wherein the knuckle includes two non-intersecting through-going passages.

Also disclosed is an apparatus, wherein the passages are square the bars have a square cross section.

Also disclosed is an apparatus, wherein the passages are non-circular and the bars have a like cross section.

Also disclosed is an apparatus, wherein the bars are fully removable from the passages and replaceable with alternative bars.

Also disclosed is an apparatus, for supporting an elongated workpiece element against at least a wall surface at a distance from a floor surface, the apparatus comprising: a handle having opposing first and second ends; the head assembly coupled to the first end of the handle, the head assembly being configured to support and surround portion of the workpiece at a prescribed distance from said floor surface when said second end of said elongate body portion is adjacent said floor surface and said first end is adjacent said at least a wall, the head having a knuckle member, having at least two through-going passages therethrough a pair of wall pads, configured to engage a wall; a pair of bars extended from the wall pads with at least a portion of which is sized to be slideably received within said passages, engagement members coupled to said knuckle member for engaging said bars to prevent movement of said bars within said knuckle when user-adjusted to a selected position, thereby creating user definable sides of a box area formed against wall surfaces.

Also disclosed is a method temporarily and adjustably maintaining an elongated workpiece adjacent a wall surface to allow further installation of the workpiece on the wall surface, comprising the steps of:
a. creating a box enclosure area around a portion of the workpiece, the box being formed of two adjacent generally orthogonal sidewalls, first and second wall pads with first and second bars orthogonal to each other and extending from the pads;
b. receiving the bars within the knuckle member having through going passages for receiving the bars and maintaining in a generally orthogonal orientation to each other;
c. adjusting the length of said first and second bars within the knuckle passageways to create a rectangular box enclosure area of preferred shape to maintain said workpiece close to the wall surface.

Also disclosed is a method wherein the step of adjusting the length of said bars includes sliding said bars within the passageway to form a preferred rectangular enclosure and then locking the bars from movement with the passageways.

### BRIEF DESCRIPTION OF THE SEVERAL VIEWS OF THE DRAWINGS

FIG. 1 is a perspective view of one aspect of the invention.

FIG. 2 is a side plan of the embodiment in FIG. 1.

FIG. 3 is a side plan, rotated 90 degrees of the embodiment in FIG. 2.

FIG. 4 is a top plan of the embodiment in FIG. 1.

FIG. 5 is a rear plan of the embodiment in FIG. 1.

FIG. 6 is a bottom plan of the embodiment in FIG. 1.

FIG. 7 is a perspective of the knuckle portion of the embodiment in FIG. 1.

FIG. 8 is a top plan view of the knuckle portion of the embodiment in FIG. 1.

FIG. 9 is a side plan view of the knuckle portion of the embodiment in FIG. 1.

FIG. 10 is a bottom plan view of the knuckle portion of the embodiment in FIG. 1.

FIG. 11 is the other side plan view of the knuckle portion of the embodiment in FIG. 9.

FIG. 12 is a view like FIG. 11 but rotated 90 degrees.

FIG. 13 is a view like FIG. 11 but rotated 180 degrees.

### DETAILED DESCRIPTION

Installation of longitudinal members at or near ceiling heights can be difficult, especially if one is working alone. Crown moldings are one type of product which falls into this category. Pipes, cables and other elements which must be mounted at heights create similar challenges. For convenience, reference will be made to workpieces or crown moldings, but it is intended that other product installations are defined to fall under nomenclature. Likewise, reference will be made to walls or ceilings. They should be considered interchangeable and may be referred to as just wall surfaces.

Crown molding serves several important aesthetic and utilitarian functions, including the obscuring of the rough and abrupt intersection of a ceiling and wall, the general enhancement and refinement of the decor and design of a room, and the stabilization of some wall coverings where they intersect with a ceiling. However, because of the inherently elevated, overhead location of crown molding, installation can be cumbersome and difficult, and often requiring the cooperation of two or more workers due particularly to the length of crown molding to be installed.

However, two or more workers are often not available or free to assist in the installation of a crown molding piece, which thus causes delays in the installation of the crown molding, or perhaps even causing a user to forego installing crown molding due to the unavailability of an assistant, which is often the scenario for a homeowner.

The present disclosure in an improvement over the prior art device disclosed in U.S. Pat. No. 7,603,817 to Lewis which discloses an apparatus for supporting a molding article/workpiece while the molding article is positioned for mounting and a method of temporarily and adjustably maintaining an elongated workpiece adjacent to a wall surface to allow further installation of the workpiece on the wall surface.

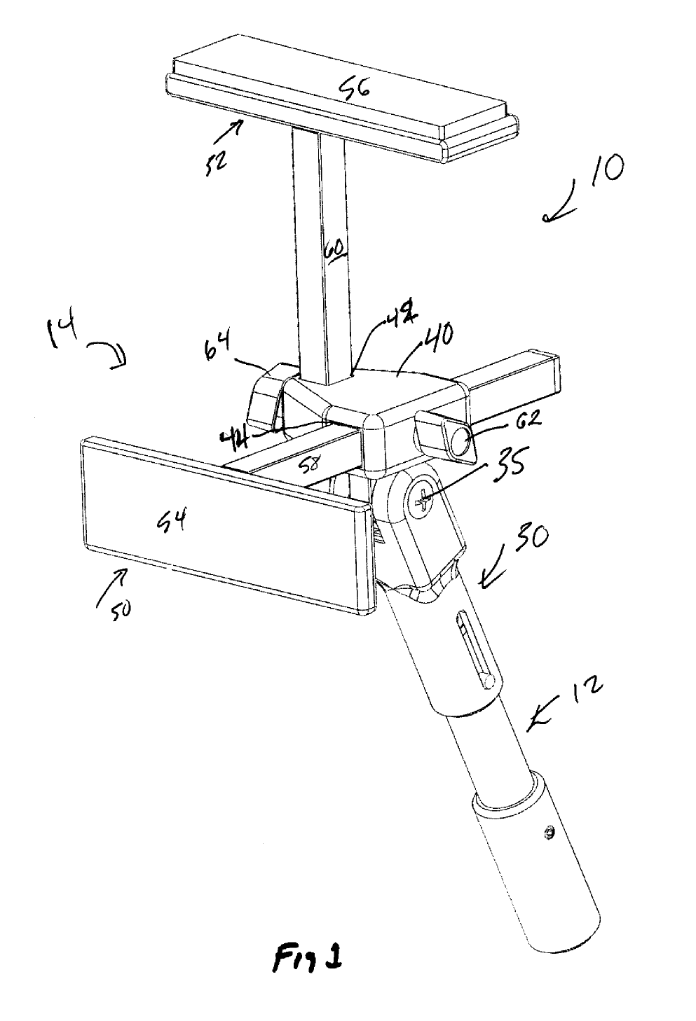

With reference to FIG. 1, the apparatus is designated generally by reference numeral 10. Apparatus 10 generally includes an extendable elongate body member/handle 12 preferably pivotally coupled to a head member 14. With particular reference now to the body member 12. The function of the handle 12 is similar to that disclosed in the above '817 patent to Lewis.

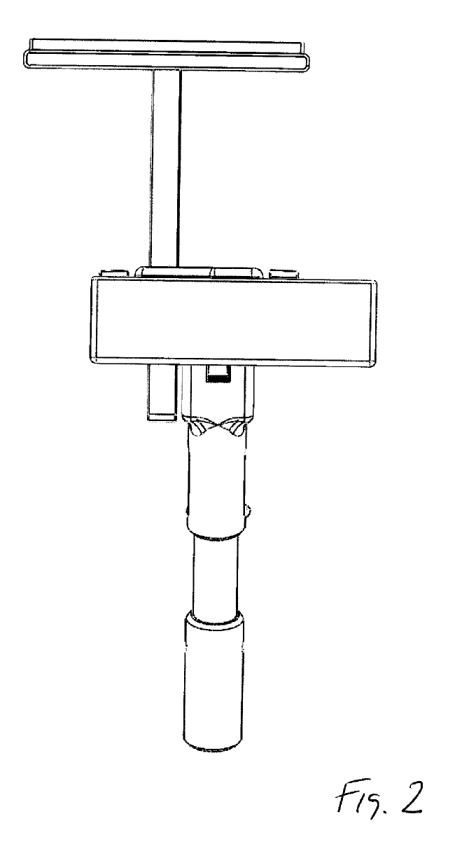

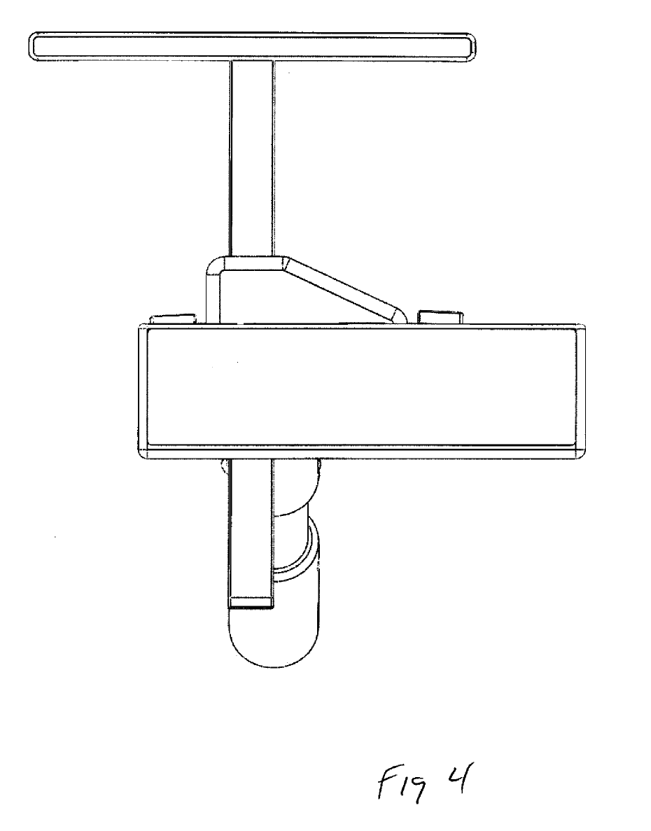

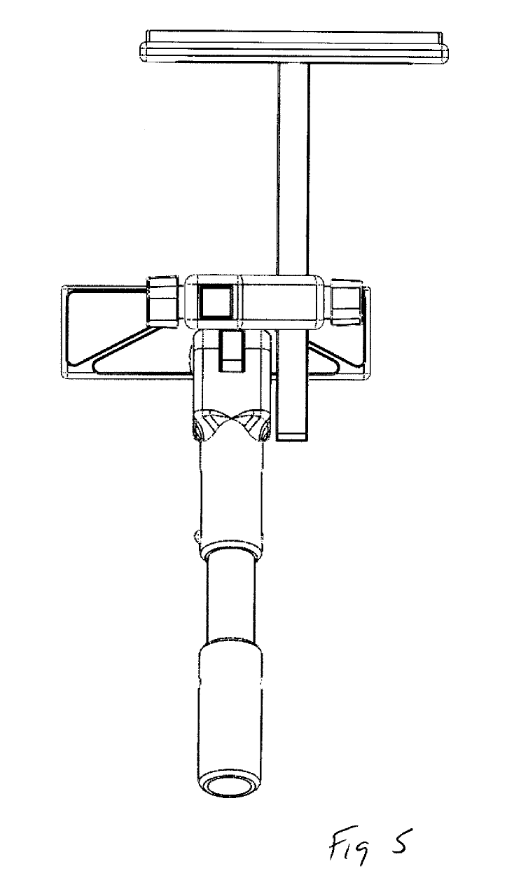

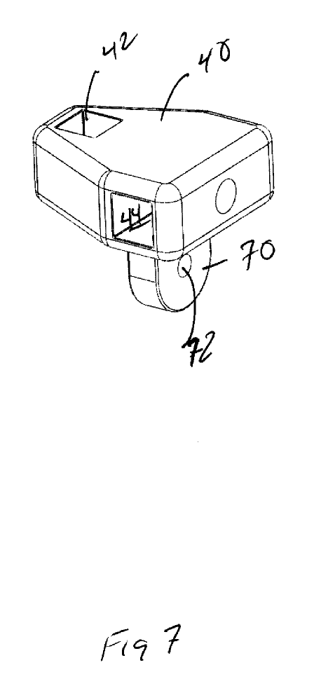

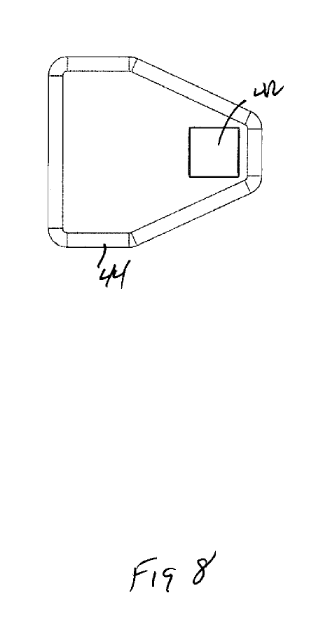

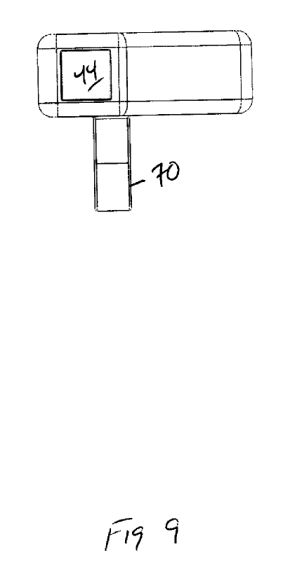

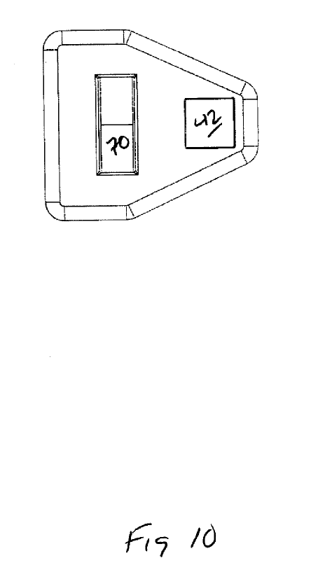

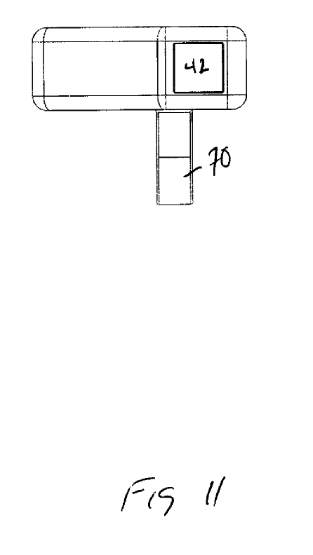

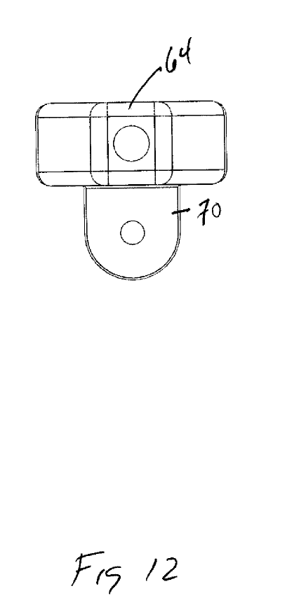

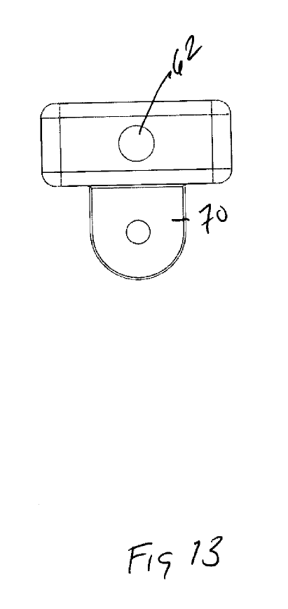

With specific reference now to FIGS. 1-6 the head assembly 14 of apparatus 10 will now be described. Head assembly 14 is pivotally connected to a aforesaid head-cap assembly 30 preferably via a conventional pin assembly 35. Head assembly preferably pivots about 180 degrees of rotation relative to end cap 30. Head assembly 14 includes a knuckle block member 40 (shown in detail in FIGS. 7-13) that pivotally connects to the end-cap assembly 30, via the pin assembly 35.

The knuckle 40 includes at least two passages 42, 44 therethrough, the passages being preferably oriented orthogonally to each other. The passages a sized to sideably receive wall contact arms 50, 52 which themselves preferably include contact pads 54,56 which extend generally and preferably orthogonally from support bars 58, 60 which may be also be pivotally attached to pads 54, 56 for additional flexibility on wall surfaces which are not at right angles or curved surfaces. Preferably the bars are fully removeable so that they can be swapped out with other bars/pads of different shape/size or attachment fixture. For example a further set of bars/pads which are longer. shorter, of different lengths, will accommodate larger or small confined spaces (boxed area) without excessive protrusion of the bars thru the passages and knuckle.

Bar 58, 60 are sized to be slideably received into passages 42, 44 with their position being fixable by clamping mechanisms or engagement members, such as the set screws 62, 64. Preferably they have the same cross sectional shape as the passages, though small enough to be received therein but preferably not rotational.

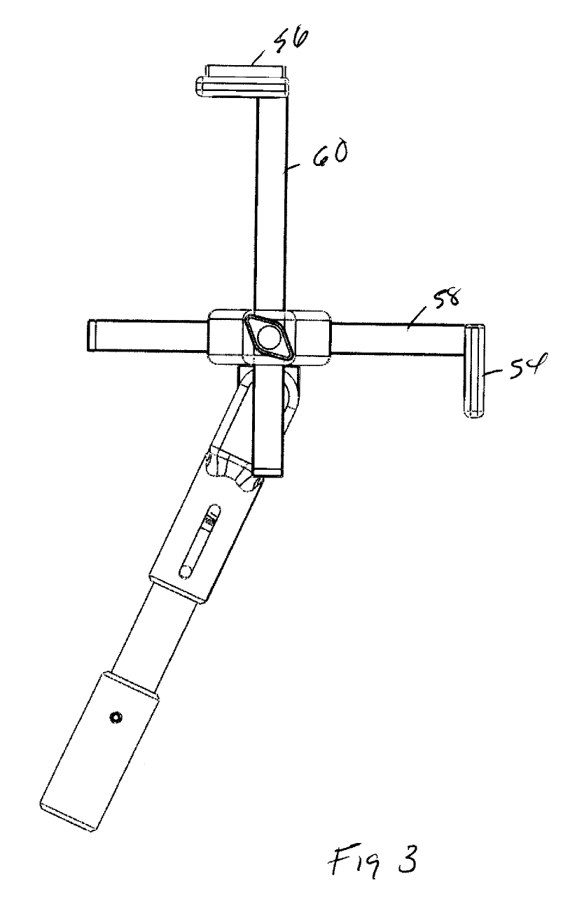

FIG. 3 shows one embodiment pads affixed to bars 58, 60 offset maximally to the right, out outside the “box” area which is defined by the two bars and the two wall portions (not shown) which created a confined area which will maintain the crown molding (or other element) bound therewithin. By offsetting the pads/feet maximally outside the box area, they will not interfere with any portion of the molding that might otherwise fit.

Knuckle 40 therefore makes it possible to define a box area of any rectangular shape according to accommodate molding or other elements to be attached to the wall require. For example, if an element to be attached, such as cable raceway, which has a greater extent in the horizontal direction than vertically, the length of the bars within the knuckle can be adjusted to suite.

It is advantageous to configure the lengths of the bars to minimize the box size since assists in maintaining the element/crown molding closer to the wall surfaces so that attachment is as small as possible.

FIGS. 7-13 illustrate knuckle 40 alone. Passages 42, 44 are offset from each other in the same horizontal plane, but the can also be stacked in the same or different vertical plan. They may have a rectangular or square cross section or preferably a non-circular cross section to prevent rotation. Circular is also possible.

To accommodate pivoting of the handle 12 on pivot 35, on the knuckle 40, a pivot flange 70 extends preferably orthogonally from the body of the knuckle. The flange includes an aperture 72, to receive pivot 72.

Other than indicated above, the shape of the knuckle 40 is dictated by aesthetics rather than function.

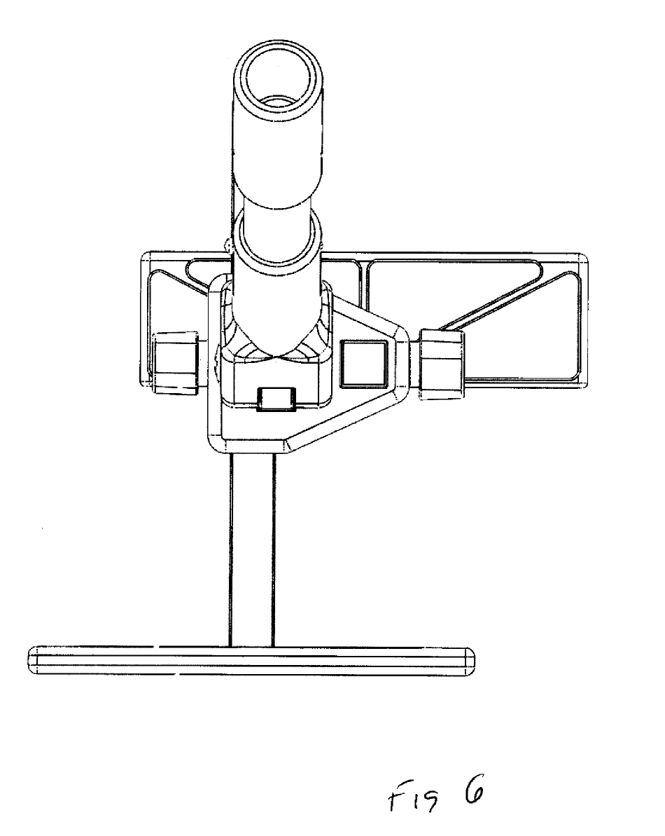

If only a sidewall is involved, such as shown in FIG. 6 of U.S. Pat. No. 7,603,817, the present disclosure envisions this option by either mounting one of pads 54, 56 on a 90-180 degree pivot or providing an alternate configuration with both pads having the same/parallel orientation.

Also disclosed is a method of temporarily and adjustably maintaining an elongated workpiece adjacent a wall surface to allow further installation of the workpiece on the wall surface, having one or more of the following steps: creating a box enclosure area around a portion of the workpiece, the box being formed of two adjacent generally orthogonal existing walls (such as a wall and a ceiling or two wall surfaces, bounding the sidewall(s) by first and second wall pads with first and second bars orthogonal extending from the pads; receiving the bars within the central point of convergence/knuckle member having through going passages for receiving the bars and maintaining in a generally orthogonal orientation to each other; adjusting the length of said first and second bars within the knuckle passageways to create a rectangular box enclosure area of a shape preferred by the user to maintain said workpiece close to the wall surface. The box enclosure being the contiguous structure of the wall(s), the bars and knuckle, which defines an enclosed spaced. The method preferably teaches adjustment of the confined space (box) to include the shape thereof is preferred for maintaining the workpiece and then locking the position of the bars in the knuckle to maintain the space.

The method further includes the step of adjusting the length of said bars includes sliding said bars within the passageway to form a preferred rectangular enclosure and then locking the bars from movement with the passageways.

The method further includes the step of swapping the bars/pads for bars/pads of different length to achieve different size box areas.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. These and other variations and modifications of the embodiments disclosed herein may be made without departing from the scope and spirit of the invention.

We claim:

1. In an apparatus for supporting an elongated workpiece element against at least a wall surface at a distance from a floor surface, the apparatus comprising: a handle having opposing first and second ends; a head assembly coupled to the first end of the handle, the head assembly being configured to support and surround portion of the workpiece at a prescribed distance from said floor surface when said second end of said elongate body portion is adjacent said floor surface and said first end is adjacent said at least a wall, the improvement comprising
a. a knuckle member, having at least two orthogonal passages there through;
b. a pair of wall pads, configured to engage a wall;
c. a pair of bars extended from the wall pads with at least a portion of which is sized to be slideably received within said passages;
d. engagement members coupled to said knuckle member for engaging said bars to prevent movement of said bars within said knuckle when user-adjusted to a selected position;
thereby creating user definable sides of a box area formed against wall surfaces.

2. The apparatus of claim 1, wherein said bars have a non-circular cross section, so that when inserted into said passages, they are prevented from rotating therein.

3. The apparatus of claim 1, wherein the pads include a high friction surface on their exterior face to engage wall surfaces without slippage.

4. The apparatus of claim 1, wherein the knuckle member includes rectangular passages sized to slideably receive said bars, and wherein said knuckle further includes at least one set screw positioned to engaged the passages and hence the bars to fix there position when the set screws are engaged on into the bars.

5. The apparatus of claim 1, wherein the knuckle further includes a pivot flange extending orthogonally from a surfaces thereof, said pivot flange being connected to the handle in such a way as to allow pivoting of the knuckle relative to the handle.

6. The apparatus of claim 1, wherein the knuckle includes two non-intersecting through-going passages.

7. The apparatus of claim 6, wherein the passages are square the bars have a square cross section.

8. The apparatus of claim 6, wherein the passages are non-circular and the bars have a like cross section.

9. The apparatus of claim 6, wherein the bars are fully removable from the passages and replaceable with alternative bars.

10. An adjustable head assembly for supporting an elongated workpiece element against at least a wall surface at a distance from a floor surface, the apparatus comprising: a handle having opposing first and second ends; the head assembly coupled to the first end of the handle, the head assembly being configured to support and surround portion of the workpiece at a prescribed distance from said floor surface when said second end of said elongate body portion is adjacent said floor surface and said first end is adjacent said at least a wall, the head comprising:
a. a knuckle member, having at least two through-going passages therethrough;
b. a pair of wall pads, configured to engage a wall;
c. a pair of bars extended from the wall pads with at least a portion of which is sized to be slideably received within said passages;
d. engagement members coupled to said knuckle member for engaging said bars to prevent movement of said bars within said knuckle when user-adjusted to a selected position;
thereby creating user definable sides of a box area formed against wall surfaces.

11. A method temporarily and adjustably maintaining an elongated workpiece adjacent a wall surface to allow further installation of the workpiece on the wall surface, comprising the steps of:
a. creating a box enclosure area around a portion of the workpiece, the box being formed of two adjacent generally orthogonal sidewalls, first and second wall pads with first and second bars orthogonal to each other and extending from the pads;
b. receiving the bars within the knuckle member having through going passages for receiving the bars and maintaining in a generally orthogonal orientation to each other;
c. adjusting the length of said first and second bars within the knuckle passageways to create a rectangular box enclosure area of preferred shape to maintain said workpiece close to the wall surface.

12. The method of claim 11, wherein the step of adjusting the length of said bars includes sliding said bars within the passageway to form a preferred rectangular enclosure and then locking the bars from movement with the passageways.

13. The method claim 11, further including the step of swapping said bars for bars of different lengths to accommodate different sized workpieces.
